(19) United States
(12) Patent Application Publication
(10) Pub. No.: US 2025/0139472 A1
(43) Pub. Date: May 1, 2025

(54) MACHINE LEARNING MODEL EXPLANATION BUILDER

(71) Applicant: Microsoft Technology Licensing, LLC, Redmond, WA (US)

(72) Inventors: Jonathan EPHRATH, Herzliya (IL); Royi RONEN, Tel Aviv (IL); Dor TENENBOIM, Tel Aviv (IL); Shahar Zvi KEREN, Hemed (IL)

(21) Appl. No.: 18/497,093

(22) Filed: Oct. 30, 2023

(51) Int. Cl. G06N 5/045; G06N 3/0475

(52) U.S. Cl. CPC G06N 5/045; G06N 3/0475

(57) ABSTRACT

A system embeds source content segments of the source content to generate input vectors of the source content segments and embeds generated content segments of the artificial-intelligence-generated content to generate output vectors of the generated content segments. The system performs a similarity measurement on the input vectors and the output vectors to generate a similarity score for each pair of input vectors and output vectors. The system defines a similarity correspondence between individual content segments of the source content to individual generated content segments of the artificial-intelligence-generated content, based on performing the similarity measurement and outputs the explanation to a user interface device. The explanation indicates generated result correspondences between the individual content segments of the source content and the individual generated content segments of the artificial-intelligence-generated content.

### BACKGROUND

The rationale behind the output of some machine learning (ML) algorithms can be difficult for humans to discern. For example, the ML model's “reasoning” behind the predictions of some “black box” models is difficult to observe and even harder to understand, even by experts in the relevant domain. An Explainable AI (XAI) system, on the other hand, is designed with the intent to help humans better understand how the AI system operates and arrives at its output. Accordingly, an XAI system aims to provide explanations of what has been done, what is being done, and what will be done next by the system and to reveal the relevant information upon which these actions were or will be taken. For example, an XAI system can be explainable to the extent that it can identify a collection of input data features that have contributed (e.g., to a greater or lesser extent) to producing a decision (e.g., classification or regression). With this information, a user can develop enhanced trust in the performance of the XAI system (e.g., because the explanation comports with the user's reasoning) or develop strategies for improving the performance of the XAI system (e.g., when the explanation conflicts with the user's reasoning).

### SUMMARY

In some aspects, the techniques described herein relate to a method of generating an explanation of artificial-intelligence-generated content corresponding to source content, the method including: embedding source content segments of the source content to generate input vectors of the source content segments; embedding generated content segments of the artificial-intelligence-generated content to generate output vectors of the generated content segments; performing a similarity measurement on the input vectors and the output vectors to generate a similarity score for each pair of input vectors and output vectors; defining a similarity correspondence between individual content segments of the source content to individual generated content segments of the artificial-intelligence-generated content, based on performing the similarity measurement; and outputting the explanation to a user interface device, wherein the explanation indicates generated result correspondences between the individual content segments of the source content and the individual generated content segments of the artificial-intelligence-generated content, based on defining the similarity correspondence between the individual content segments of the source content to the individual generated content segments of the artificial-intelligence-generated content.

In some aspects, the techniques described herein relate to a system for generating an explanation of artificial-intelligence-generated content corresponding to source content, the system including: one or more hardware processors; one or more embedding models executable by the one or more hardware processors and configured to embed source content segments of the source content to generate input vectors of the source content segments and to embed generated content segments of the artificial-intelligence-generated content to generate output vectors of the generated content segments; a similarity evaluator executable by the one or more hardware processors and configured to perform a similarity measurement on the input vectors and the output vectors to generate a similarity score for each pair of input vectors and output vectors; and an explanation builder executable by the one or more hardware processors and configured to define a similarity correspondence between individual content segments of the source content to individual generated content segments of the artificial-intelligence-generated content based on the similarity score satisfying a similarity condition, based on performing the similarity measurement, wherein the explanation builder is further configured to output the explanation to a user interface device, wherein the explanation indicates generated result correspondences between the individual content segments of the source content and the individual generated content segments of the artificial-intelligence-generated content, based on defining the similarity correspondence between the individual content segments of the source content to the individual generated content segments of the artificial-intelligence-generated content.

In some aspects, the techniques described herein relate to one or more tangible processor-readable storage media embodied with instructions for executing on one or more processors and circuits of a computing device a process for generating an explanation of artificial-intelligence-generated content corresponding to source content, the process including: embedding source content segments of the source content to generate input vectors of the source content segments, wherein at least one of the source content segments includes a sentence, a paragraph, a language phrase, a language term, audio content, image content, or video content; embedding generated content segments of the artificial-intelligence-generated content to generate output vectors of the generated content segments, wherein at least one of the generated content segments includes a sentence, a paragraph, a language phrase, a language term, audio content, image content, or video content; performing a similarity measurement on the input vectors and the output vectors to generate a similarity score for each pair of input vectors and output vectors; defining a similarity correspondence between individual content segments of the source content to individual generated content segments of the artificial-intelligence-generated content based on the similarity score satisfying a similarity condition, based on performing the similarity measurement; and outputting the explanation to a user interface device, wherein the explanation indicates generated result correspondences between the individual content segments of the source content and the individual generated content segments of the artificial-intelligence-generated content, based on defining the similarity correspondence between the individual content segments of the source content to the individual generated content segments of the artificial-intelligence-generated content.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example use case flow for generating an explanation of a machine learning model's output.

FIG. 2 illustrates an example system for generating an explanation of a machine learning model's output in an email context.

FIG. 3 illustrates an example system for generating an explanation of a machine learning model's output.

FIG. 4 illustrates example operations of generating an explanation of a machine learning model's output using similarity evaluations.

FIG. 5 illustrates example operations for generating an explanation of a machine learning model's output using generative AI relevancy evaluations.

FIG. 6 illustrates an example computing device for use in implementing the described technology.

### DETAILED DESCRIPTIONS

The operational elements of a machine learning model are often hidden from a user. For example, in a machine learning model designed to generate email replies, a user can typically examine the source email (which is used as input to the email reply generator) and the generated email reply, but it is difficult for the user to discern how the machine learning model arrived at the resulting reply. For example, in some situations, the artificial intelligence may hallucinate to generate a reply that does not make sense in response to the source email, but there is little or no observability of how the machine learning model generated the nonsensical output. As such, developing confidence in a specific result and/or understanding how to improve the model's accuracy can be elusive.

To address this obstacle and to better understand how a specific machine learning model works, a technique referred to as a “generative AI explanation” is intended to help a human understand how the machine learning model generates its output from specific input. One such explanation method is referred to as “Integrated Gradients,” which involves computing the integral of the gradients of the output with respect to the input along a straight-line path from a baseline input to the actual input. Another explanation method is referred to as Layer-wise Relevance Propagation (LRP), which involves recursively propagating relevance scores from the output layer to the input layer. Other explanation methods may be employed to reveal how a machine learning model works.

The described technology generates correspondences between content segments (e.g., sentences) in the source content (e.g., a source email) and content segments in the draft result (e.g., the generated draft reply) for review by a user. In one implementation, the correspondence is illustrated by an “explanation” that maps generated sentences of an AI-generated email reply to sentences of the source email to which the generated email reply is suggested as a response. The mapping indicates the source content sentences predicted to have contributed to the generation of the generated content sentences (e.g., the source email sentences that contributed the most to the generation of the reply email sentences).

Accordingly, the described technology provides various technical benefits. One example benefit provides a model analyzer (e.g., an explanation builder) that can discern the inner workings of a machine learning model with varying levels of confidence. Such internal information is not readily accessible by a human operator or other monitoring tools. In contrast, the described technology employs techniques extracting an explanation about how a generative machine learning model has generated its results by discerning patterns and other information about the performance of the generative machine learning model. In one implementation, the explanation builder predicts the contribution an input segment (e.g., a source email sentence) makes in the generation of an output segment (e.g., a generated reply email sentence). The higher the confidence score and/or similarity measurement in this prediction for a given input segment and a given output segment, the more likely that a particular input segment has strongly influenced the generation of the corresponding output segment. Accordingly, the explanation builder predicts which input segments correspond to which generated output segments. In most implementations, a resulting explanation report lists multiple “correspondences” between input segments and output segments, which exposes the inner workings of the model and allows a user to evaluate whether the generated output is accurate or, alternatively, inaccurate (e.g., reflects the result of a hallucination).

Moreover, the explanations may be employed to identify a poor-performing model to suggest improved retraining of the model and/or other improvements to the model. For example, a user can identify inaccurate generated result correspondences, which can trigger model redesign/retraining to remove similar inaccurate results in the future.

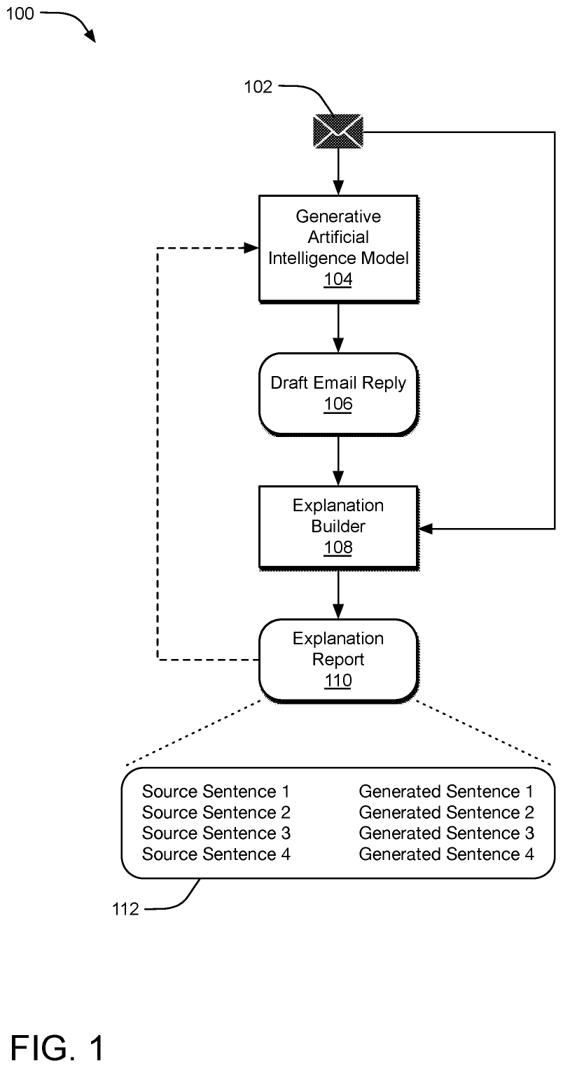

FIG. 1 illustrates an example use case flow 100 for generating an explanation of a machine learning model's output. A source email 102 is input to a generative artificial intelligence model 104, which may include a large language model (LLM) or another generative AI model. The generative artificial intelligence model 104 generates a draft email reply 106 based on the source email 102.

A user, however, may wish to evaluate the draft email reply 106 to evaluate its appropriateness and accuracy, for example. Absent an explanation of how the generative artificial intelligence model 104 developed the draft email reply 106, the user may have little helpful information for evaluating the model's output, other than the draft email reply 106 itself. In various implementations of the described technology, an explanation builder 108 evaluates the source email 102 and the draft email reply 106 to provide a correspondence between content segments of draft email reply 106 and content segments of the source email 102 to provide the user with context indicating which content segments of the source email 102 contributed (e.g., in some cases, contributed most) to the generation of the content segments of the draft email reply 106. Content segments may include a sentence, a paragraph, a language phrase, a language term, audio content, image content, and/or video content (e.g., generating an explanation of a group of frames), although other segments of content may be included (e.g., metadata).

The explanation builder 108 generates an explanation report 110 that includes a generated result correspondence 112 between the individual content segments of the source email 102 (e.g., source content) and the individual generated content segments of the draft email reply 106 (e.g., artificial-intelligence-generated content) and is shown as an example listing in FIG. 1. The generated result correspondence 112 is illustrated in a list of generated sentences from the explanation builder 108 and the corresponding source sentences from the source email 102 that are predicted to have contributed (e.g., contributed the most) to the generation of each generated sentence. It should be understood that “correspondence” in generated result correspondence 112 is indicated by the source sentence and the generated sentence being on the same line of the listing, although other methods of showing correspondence may also be employed, including tags, database relations, data pointers, etc.

In addition, the explanation report 110 can indicate some generated result correspondences that are deemed to be inaccurate (e.g., inaccurate because of a hallucination, improperly biased, offensive, etc.). The inaccurate correspondence can be identified and fed back into the model design/training workflow to remove similar inaccurate results in the future.

It should be understood that the explanation builder 108 can be used in applications outside of email contexts. For example, the explanation builder 108 may be applied to summarizing content (e.g., academic papers, articles, legal opinions, technical descriptions), responding to user queries (e.g., Bing chat using ChatGPT), conversational chatbots (e.g., whether textural, audial, or visual), and other applications of generative AI.

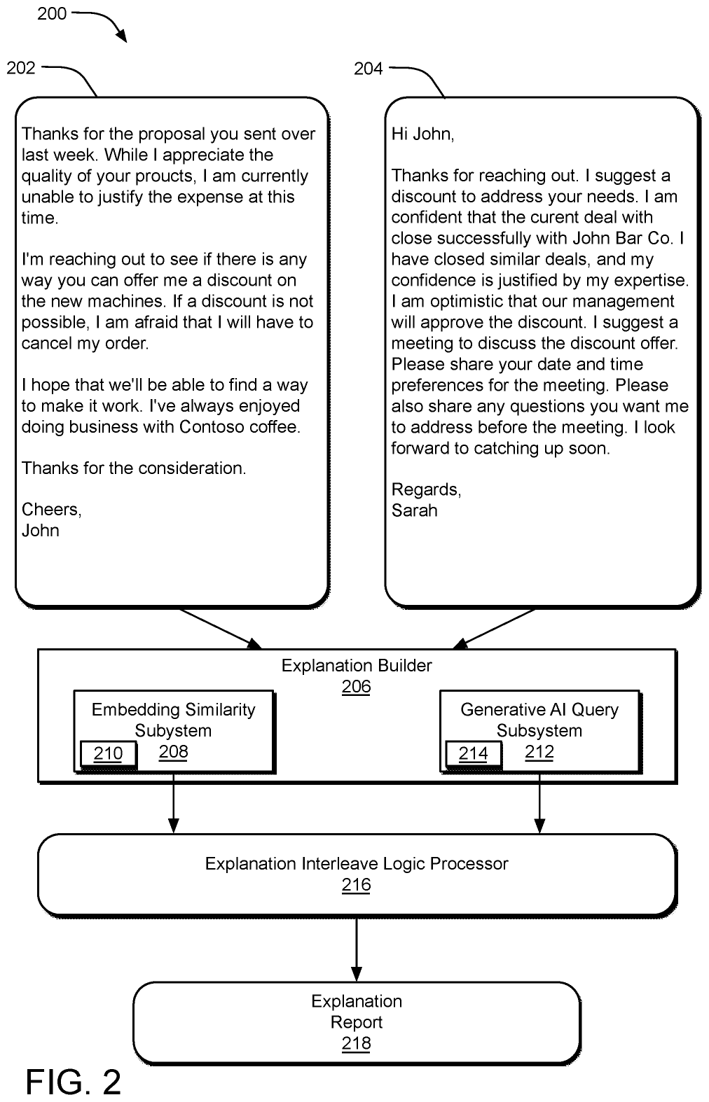

FIG. 2 illustrates an example system 200 for generating an explanation of a machine learning model's output in an email context. A source email 202 represents an inquiry from a potential customer about the possibility of a discount on an order for Contoso coffee products. A generated reply email 204 represents content generated by a generative AI model (e.g., including a large language model) in response to the source email 202. In a quick review of the source email 202 and the generated reply email 204, it is difficult for a human to discern which sentences of the generated reply email 204 were generated primarily in response to which sentences of the source email 202. Some correspondence may be detected by visual inspection by a human, but much of that may be mere speculation.

Accordingly, an explanation builder 206 analyzes content segments of the source email 202 and the generated reply email 204 to provide an explicit correspondence between at least some of the sentences of the generated reply email 204 and at least some of the sentences of the source email 202. In some implementations, unimportant content segments of the source email 202 and/or the generated reply email 204 may be excluded from the analysis, including, without limitation, salutations, closings, template language (e.g., boilerplate language already vetted by an organization).

In one implementation, the explanation builder 206 includes an embedding similarity subsystem 208, which may include one or more embedding models 210 configured to generate input vectors representing the content segments of the source email 202 and output vectors representing the content segments of the generated reply email 204 in a vector space. The embedding similarity subsystem 208 measures a similarity (e.g., using a cosine similarity technique or another similarity measurement technique) and outputs a similarity score for each corresponding pair of input vectors and output vectors. The similarity scores for each corresponding pair of input vectors and output vectors are used by the embedding similarity subsystem 208 to identify the content segments of the source email 202 predicted to have most likely contributed to the generation of corresponding content segments of the generated reply email 204. The highest scoring pairings may be output in an explanation as generated result correspondences or as similarity correspondences that are evaluated against relevancy correspondences by an explanation interleave logic processor 216 (see below) to yield generated result correspondences in an explanation report 218.

In another implementation, the explanation builder 206 includes a generative AI query subsystem 212, which may include one or more generative AI models 214 configured to indicate a relevancy correspondence between each segment of the generated content segments and a corresponding segment of the source content segments predicted most likely to generate the generated segment. Each relevancy correspondence indicates a confidence score characterizing the correspondence prediction. The explanation builder 206 outputs the confidence for each pair of input vectors and output vectors. The highest scoring pairings may be output in an explanation as generated result correspondences or as relevancy correspondences that are evaluated against similarity correspondences by the explanation interleave logic processor 216 (see above) to yield generated result correspondences the explanation report 218.

The explanation interleave logic processor 216 may be used to select the most relevant content segments of the source email 202 corresponding to the generation of the generated reply email 204 from the similarity correspondences and the relevancy correspondences if both are available. The explanation interleave logic processor 216 can also apply rankings, constraint-based filtering (e.g., limiting the generated result correspondences to the top k correspondences), or other filtering to a listing of the correspondences to yield a ranked and/or filtered listing of generated result correspondences for inclusion in the explanation report 218. The rankings, constraints, and other filtering parameters may be implemented with respect to an interleaved explanation logic condition. For example, the interleaved explanation logic condition may apply a threshold on the number of pairs of corresponding segments that may be listed in an explanation or a threshold below which a similarity score and/or relevancy score would exclude the pairs of corresponding segments from the explanation.

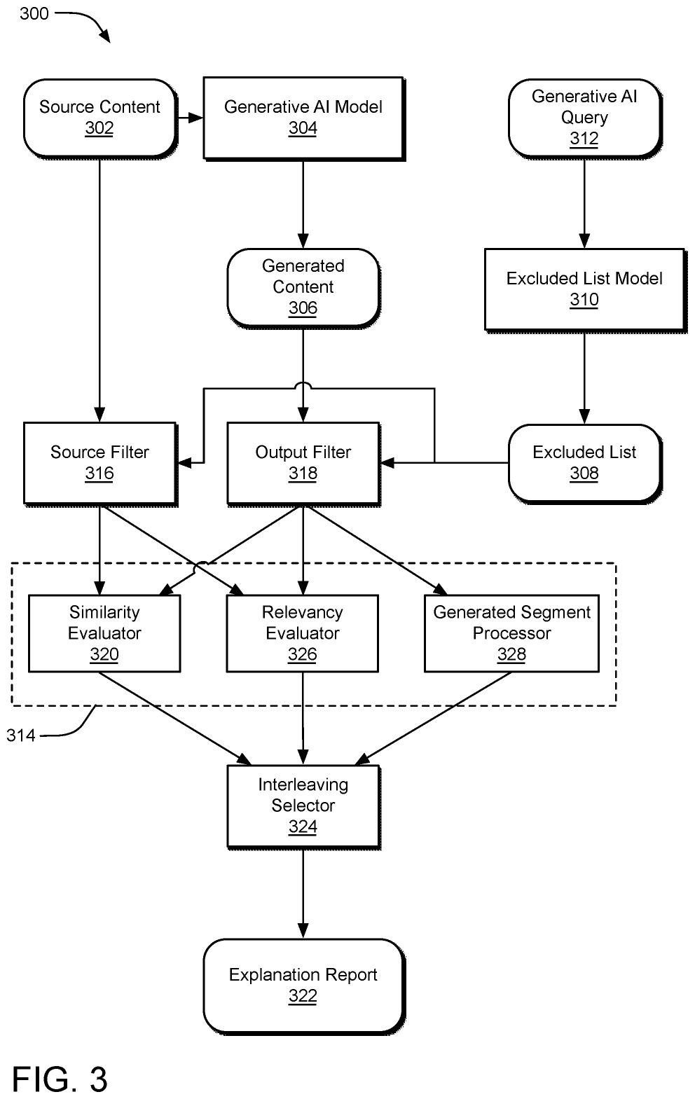

FIG. 3 illustrates an example system 300 for generating an explanation of a machine learning model's output. Source content 302 (e.g., a received email, an article) is input to a generative AI model 304, which creates generated content 306 (e.g., a suggested email reply, a summary of the article). The described technology creates generated result correspondences, which include a list of generated content segments from an explanation builder and the corresponding source content segments from the source content that are predicted to have contributed (e.g., contributed the most) to the generation of each generated content segment. It should be understood that “correspondence” in a generated result correspondence is indicated by the source sentence and the generated sentence being on the same line of the listing, although other methods of showing correspondence may also be employed, including tags, database relations, data pointers, etc.

In some implementations, the described technology appreciates that some content of the source content 302 and/or generated content 306 may be unimportant to the generation of the explanation, such as salutations, signature blocks, etc. As such, there may be little value in generating an explanation that includes a generated result correspondence for such content segments. Accordingly, an excluded list 308 is generated by a generative AI model (e.g., see the excluded list model 310) in response to a generative AI query 312 (e.g., “create large data of: opening sentences, closing sentences, email boilerplate/template sentences”). The excluded list 308 lists content segments that are to be filtered from the source content 302 and generated content 306 when input to an explanation builder 314. The source content 302 and the excluded list 308 are input to a source filter 316 to filter out such excluded content segments from the source content 302. The generated content 306 and the excluded list 308 are input to an output filter 318 to filter out such excluded content segments from the generated content 306.

In one implementation, the passed segments of the filtered source content and passed segments of the filtered generated content are input to a similarity evaluator 320 of the explanation builder 314. The similarity evaluator 320 embeds (e.g., using an embedding machine learning model) the passed segments of the filtered source content and the filtered generated content, yielding corresponding input vectors and output vectors, respectively, in a vector space. The similarity evaluator 320 performs a similarity measurement (e.g., a cosine similarity measurement or another viable similarity measurement) on each passed segment of the generated content 306 with respect to each passed segment of the source content 302 to yield a similarity score for each such pair of segments. If the similarity score satisfies a similarity condition (e.g., exceeds a threshold), then those pairs of segments are output to an explanation report 322 in some implementations, although in other implementations, the pairs of segments are further filtered by one or more constraints (e.g., only including the top k scoring pairs of segments-see below) and/or are further selected by an interleaving selector 324 in combination with pairs of segments that are also output from a relevancy evaluator 326 (see below) based on their similarity scores.

In one implementation, the passed segments of the filtered source content and passed segments of the filtered generated content are input to the relevancy evaluator 326 of the explanation builder 314. The relevancy evaluator 326 submits the passed segments of the filtered source content and the filtered generated content with a relevancy query to a generative AI model (e.g., including a large language model) to generate a relevancy correspondence. An example relevancy query may be “extract, for each generated sentence, a sentence from the source content that explains the generated sentence the most” or some other similar query.

The generative AI model outputs generated content segments and the corresponding source content segments, along with a confidence score of how confident the generative AI model is in the relevancy of the source content segment to the generation of the corresponding generated content segment. If the confidence scores satisfy a relevancy condition (e.g., exceeds a threshold), then the corresponding pairs of segments are output to an explanation report 322 in some implementations, although in other implementations, the pairs of segments are further filtered by one or more constraints (e.g., only including the top k scoring pairs of segments-see below) and/or are further selected by an interleaving selector 324 in combination with pairs of segments that are also output from a similarity evaluator 320 (see above).

As described above, the interleaving selector 324 can evaluate the outputs of the similarity evaluator 320 and the relevancy evaluator 326 to select the most relevant corresponding pairs of segments. In one implementation, the similarity scores and the relevancy scores are normalized (e.g., between 0 and 1, potentially subject to some weightings), and the pairs of segments having the highest normalized scores (e.g., showing the strongest generated result correspondence) are included in the 322.

As previously introduced, various constraints may be applied to the content of the explanation report 322 by a generated segment processor 328. For example, it may be decided to limit the number of corresponding source segments and generated segments that are included in the explanation report 322. For example, the corresponding source and generated segments may be ranked based on the comparative strengths of their similarity scores and/or relevancy scores (which may be mutually normalized), and then a maximum of k pairs of segments are included in the explanation. In one implementation, this approach, which can be executed by the interleaving selector 324, limits the pairs of segments included in the explanation report to the k most meaningful correspondence pairs.

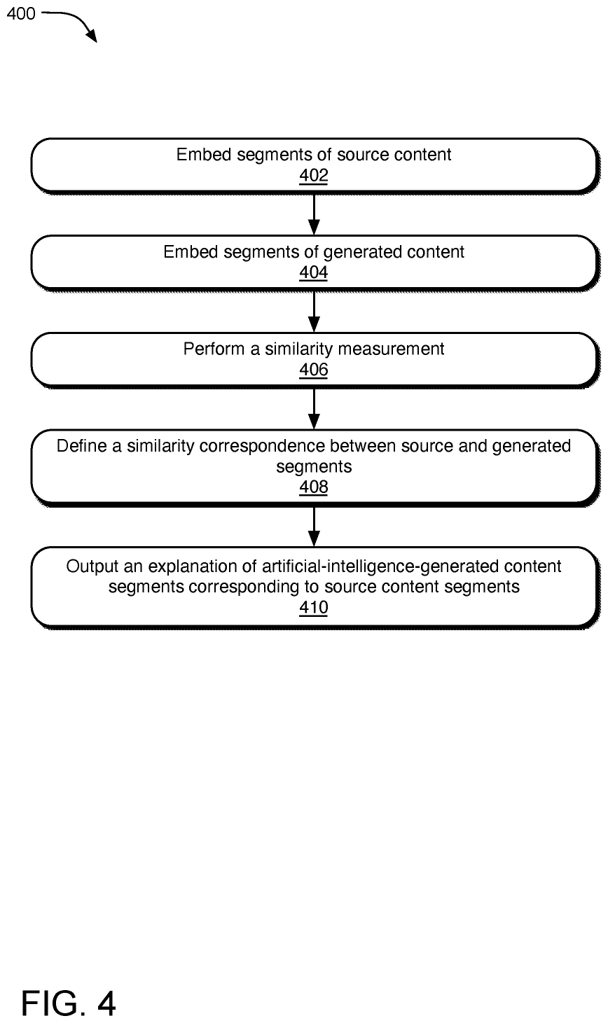

FIG. 4 illustrates example operations 400 of generating an explanation of a machine learning model's output using similarity evaluations. An embedding operation 402 embed segments of the source content to generate input vectors of the source content segments. Another embedding operation 404 embeds segments of the artificial-intelligence-generated content to generate output vectors of the generated content segments. A measuring operation 406 performs a similarity measurement on pairs of input vectors and output vectors, yielding a similarity score for each pair.

A correspondence operation 408 defines a similarity correspondence between source segments and generated segments based on the similarity scores of each pair of input/output vectors satisfying a similarity condition. For example, vector pairs having similarity scores below a certain threshold may be excluded, while those equaling or exceeding that threshold are defined to have a similarity correspondence for potential listing in an explanation report (e.g., subject to ranking, subject to a constraint on the number of pairs to be listed in the explanation report, subject to an interleaving evaluation of the similarity scores of these pairs with the relevancy scores of these and/or other pairs). Based on the similarity scores of the input and output vectors, an outputting operation 410 outputs an explanation including appropriate pairs of segments (e.g., source content segments that have satisfactory correspondence to generated content segments, such as source content segments that contribute the most to the generation of the corresponding generated content segments).

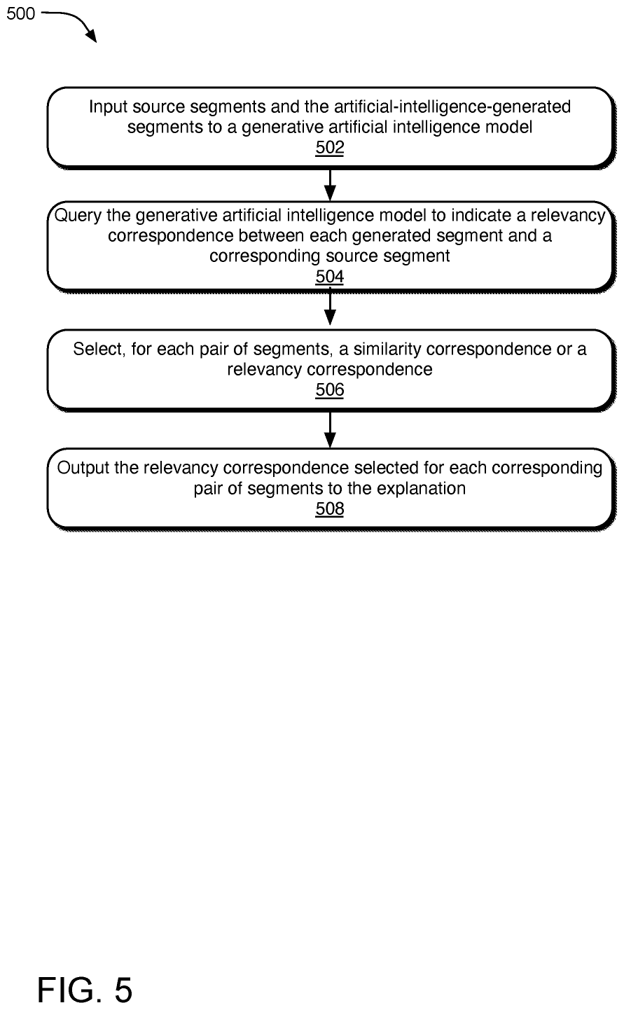

It should be understood that the operations 400 may be performed in combination with the operations described with respect to FIG. 5 in some implementations, so as to consider both vector similarity (described with respect to FIG. 4) and generative AI relevancy evaluations (described with respect to FIG. 5). In some such implementations, additional operations of selecting, for each corresponding pair of content segments, a similarity correspondence or a relevancy correspondence based on either a corresponding similarity score or a corresponding confidence score satisfying an interleaved explanation logic condition, and/or adding the similarity correspondence or the relevancy correspondence selected for each corresponding pair of content segments to the explanation that is output to the user interface device, may be executed.

FIG. 5 illustrates example operations 500 for generating an explanation of a machine learning model's output using generative AI relevancy evaluations. An inputting operation 502 inputs the source content segments and the artificial-intelligence-generated content segments to a generative artificial intelligence model. A query operation 504 queries the generative artificial intelligence model to indicate a relevancy correspondence between each segment of the generated content segments and a corresponding segment of the source content segments predicted most likely to generate the generated segment. The query operation 504 may also output a confidence score for each pair of corresponding segments.

A defining operation 506 defines a relevancy correspondence between source segments and generated segments. An outputting operation 508 outputs an explanation of artificial-intelligence-generated content corresponding to source content.

It should be understood that the operations 500 may be performed in combination with the operations described with respect to FIG. 5 in some implementations, so as to consider both vector similarity (described with respect to FIG. 4) and generative AI relevancy evaluations (described with respect to FIG. 5). In some such implementations, additional operations of selecting, for each corresponding pair of content segments, a similarity correspondence or a relevancy correspondence based on either a corresponding similarity score or a corresponding confidence score satisfying an interleaved explanation logic condition, and/or adding the similarity correspondence or the relevancy correspondence selected for each corresponding pair of content segments to the explanation that is output to the user interface device, may be executed.

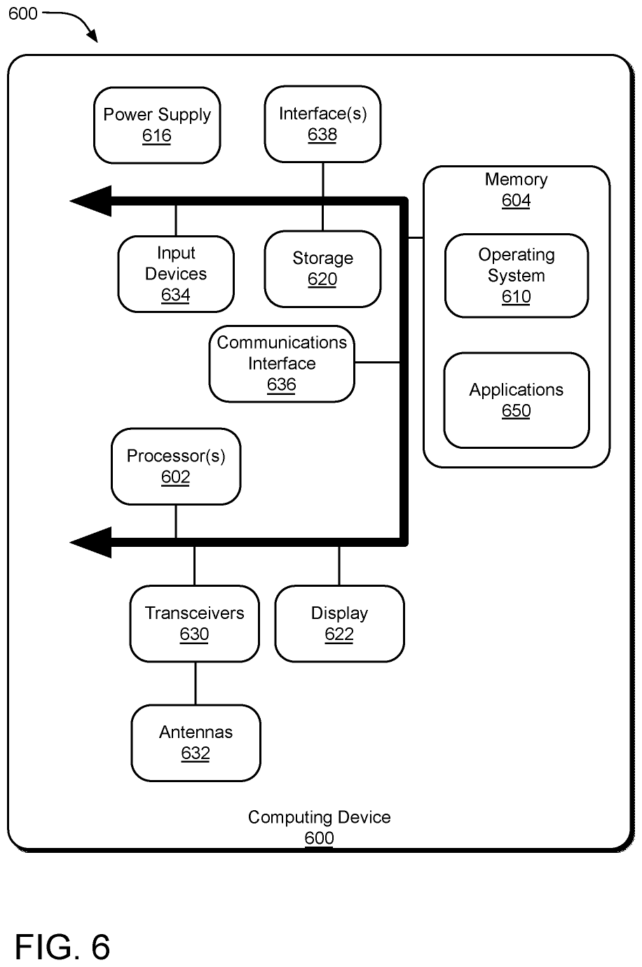

FIG. 6 illustrates an example computing device 600 for use in implementing the described technology. The computing device 600 may be a client computing device (such as a laptop computer, a desktop computer, or a tablet computer), a server/cloud computing device, an Internet-of-Things (IoT), any other type of computing device, or a combination of these options. The computing device 600 includes one or more processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 620.

In the example computing device 600, as shown in FIG. 6, one or more modules or segments, such as applications 650, a generative artificial intelligence model, an excluded list model, an explanation builder, an embedding similarity subsystem, a generative AI query subsystem, an explanation interleave logic processor, an interleaving selector, a similarity evaluator, ad relevancy evaluator, a generated segment processor, filters, and other program code and modules may be loaded into the operating system 610 on the memory 604 and/or the storage 620 and executed by the processor(s) 602. The storage 620 may store explanation reports, similarity correspondences, source content, generated content, similarity scores, confidence scores, excluded lists queries, and other data and be local to the computing device 600 or may be remote and communicatively connected to the computing device 600. In particular, in one implementation, components of a system for generating an explanation of artificial-intelligence-generated content corresponding to source content may be implemented entirely in hardware or in a combination of hardware circuitry and software.

The computing device 600 includes a power supply 616, which may include or be connected to one or more batteries or other power sources, and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible communications signals (such as signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.
Clause 1. A method of generating an explanation of artificial-intelligence-generated content corresponding to source content, the method comprising: embedding source content segments of the source content to generate input vectors of the source content segments; embedding generated content segments of the artificial-intelligence-generated content to generate output vectors of the generated content segments; performing a similarity measurement on the input vectors and the output vectors to generate a similarity score for each pair of input vectors and output vectors; defining a similarity correspondence between individual content segments of the source content to individual generated content segments of the artificial-intelligence-generated content, based on performing the similarity measurement; and outputting the explanation to a user interface device, wherein the explanation indicates generated result correspondences between the individual content segments of the source content and the individual generated content segments of the artificial-intelligence-generated content, based on defining the similarity correspondence between the individual content segments of the source content to the individual generated content segments of the artificial-intelligence-generated content.
Clause 2. The method of clause 1, wherein at least one of the source content segments and at least one of the generated content segments includes a sentence, a paragraph, a language phrase, a language term, audio content, image content, or video content.
Clause 3. The method of clause 1, further comprising: inputting the source content segments and the generated content segments to a generative artificial intelligence model; and querying the generative artificial intelligence model to indicate a relevancy correspondence between each generated segment of the generated content segments and a corresponding input segment of the source content segments predicted most likely to generate the generated segment, each relevancy correspondence indicating a confidence score.
Clause 4. The method of clause 3, wherein the explanation indicates at least one generated result correspondence selected between the individual content segments of the source content and the individual generated content segments of the artificial-intelligence-generated content.
Clause 5. The method of clause 3, further comprising: selecting, for each corresponding pair of content segments, a similarity correspondence or a relevancy correspondence based on either a corresponding similarity score or a corresponding confidence score satisfying an interleaved explanation logic condition; and adding the similarity correspondence or the relevancy correspondence selected for each corresponding pair of content segments to the explanation that is output to the user interface device.
Clause 6. The method of clause 1, further comprising: ranking the generated result correspondences to yield ranked generated result correspondences; and limiting the explanation to include a predefined number of the ranked generated result correspondences.
Clause 7. The method of clause 1, further comprising: providing a block list of content segments to be filtered out of the source content; and filtering out segments in the block list before determining the generated result correspondences between the individual content segments of the source content and the individual generated content segments of the artificial-intelligence-generated content.
Clause 8. A system for generating an explanation of artificial-intelligence-generated content corresponding to source content, the system comprising: one or more hardware processors; one or more embedding models executable by the one or more hardware processors and configured to embed source content segments of the source content to generate input vectors of the source content segments and to embed generated content segments of the artificial-intelligence-generated content to generate output vectors of the generated content segments; a similarity evaluator executable by the one or more hardware processors and configured to perform a similarity measurement on the input vectors and the output vectors to generate a similarity score for each pair of input vectors and output vectors; and an explanation builder executable by the one or more hardware processors and configured to define a similarity correspondence between individual content segments of the source content to individual generated content segments of the artificial-intelligence-generated content based on the similarity score satisfying a similarity condition, based on performing the similarity measurement, wherein the explanation builder is further configured to output the explanation to a user interface device, wherein the explanation indicates generated result correspondences between the individual content segments of the source content and the individual generated content segments of the artificial-intelligence-generated content, based on defining the similarity correspondence between the individual content segments of the source content to the individual generated content segments of the artificial-intelligence-generated content.
Clause 9. The system of clause 8, wherein at least one of the source content segments and at least one of the generated content segments includes a sentence, a paragraph, a language phrase, a language term, audio content, image content, or video content.
Clause 10. The system of clause 8, further comprising: a generative artificial intelligence model executable by the one or more hardware processors and configured to receive the source content segments and the generated content segments to the generative artificial intelligence model and querying the generative artificial intelligence model to indicate a relevancy correspondence between each generated segment of the generated content segments and a corresponding input segment of the source content segments predicted most likely to generate the generated segment, each relevancy correspondence indicating a confidence score.
Clause 11. The system of clause 10, wherein the explanation indicates at least one generated result correspondence selected between the individual content segments of the source content and the individual generated content segments of the artificial-intelligence-generated content based on each confidence score satisfying a relevancy condition.
Clause 12. The system of clause 10, further comprising: an explanation interleave logic processor executable by the one or more hardware processors and configured to select, for each corresponding pair of content segments, a similarity correspondence or a relevancy correspondence based on either a corresponding similarity score or a corresponding confidence score satisfying an interleaved explanation logic condition, the explanation interleave logic processor being further configured to add the similarity correspondence or the relevancy correspondence selected for each corresponding pair of content segments to the explanation that is output to the user interface device.
Clause 13. The system of clause 8, further comprising: a generated segment processor executable by the one or more hardware processors and configured to rank the generated result correspondences to limit the explanation to include a predefined number of ranked generated result correspondences.
Clause 14. The system of clause 8, further comprising: a block list model executable by the one or more hardware processors and configured to generate a block list of content segments to be filtered out of the source content; and a filter executable by the one or more hardware processors and configured to filter out the content segments in the block list before determining the generated result correspondences between the individual content segments of the source content and the individual generated content segments of the artificial-intelligence-generated content.
Clause 15. One or more tangible processor-readable storage media embodied with instructions for executing on one or more processors and circuits of a computing device a process for generating an explanation of artificial-intelligence-generated content corresponding to source content, the process comprising: embedding source content segments of the source content to generate input vectors of the source content segments, wherein at least one of the source content segments includes a sentence, a paragraph, a language phrase, a language term, audio content, image content, or video content; embedding generated content segments of the artificial-intelligence-generated content to generate output vectors of the generated content segments, wherein at least one of the generated content segments includes a sentence, a paragraph, a language phrase, a language term, audio content, image content, or video content; performing a similarity measurement on the input vectors and the output vectors to generate a similarity score for each pair of input vectors and output vectors; defining a similarity correspondence between individual content segments of the source content to individual generated content segments of the artificial-intelligence-generated content based on the similarity score satisfying a similarity condition, based on performing the similarity measurement; and outputting the explanation to a user interface device, wherein the explanation indicates generated result correspondences between the individual content segments of the source content and the individual generated content segments of the artificial-intelligence-generated content, based on defining the similarity correspondence between the individual content segments of the source content to the individual generated content segments of the artificial-intelligence-generated content.
Clause 16. The one or more tangible processor-readable storage media of clause 15, wherein the process further comprises: inputting the source content segments and the generated content segments to a generative artificial intelligence model; and querying the generative artificial intelligence model to indicate a relevancy correspondence between each generated segment of the generated content segments and a corresponding input segment of the source content segments predicted most likely to generate the generated segment, each relevancy correspondence indicating a confidence score.
Clause 17. The one or more tangible processor-readable storage media of clause 16, wherein the explanation indicates at least one generated result correspondence selected between the individual content segments of the source content and the individual generated content segments of the artificial-intelligence-generated content based on each confidence score satisfying a relevancy condition.
Clause 18. The one or more tangible processor-readable storage media of clause 16, wherein the process further comprises: selecting, for each corresponding pair of content segments, a similarity correspondence or a relevancy correspondence based on either a corresponding similarity score or a corresponding confidence score satisfying an interleaved explanation logic condition; and adding the similarity correspondence or the relevancy correspondence selected for each corresponding pair of content segments to the explanation that is output to the user interface device.
Clause 19. The one or more tangible processor-readable storage media of clause 15, wherein the process further comprises: ranking the generated result correspondences to yield ranked generated result correspondences.
Clause 20. The one or more tangible processor-readable storage media of clause 15, wherein the process further comprises: providing a block list of content segments to be filtered out of the source content; and filtering out the content segments in the block list before determining the generated result correspondences between the individual content segments of the source content and the individual generated content segments of the artificial-intelligence-generated content.
Clause 21. A system for generating an explanation of artificial-intelligence-generated content corresponding to source content, the system comprising: means for embedding source content segments of the source content to generate input vectors of the source content segments; means for embedding generated content segments of the artificial-intelligence-generated content to generate output vectors of the generated content segments; means for performing a similarity measurement on the input vectors and the output vectors to generate a similarity score for each pair of input vectors and output vectors; means for defining a similarity correspondence between individual content segments of the source content to individual generated content segments of the artificial-intelligence-generated content, based on performing the similarity measurement; and means for outputting the explanation to a user interface device, wherein the explanation indicates generated result correspondences between the individual content segments of the source content and the individual generated content segments of the artificial-intelligence-generated content, based on defining the similarity correspondence between the individual content segments of the source content to the individual generated content segments of the artificial-intelligence-generated content.
Clause 22. The system of clause 21, wherein at least one of the source content segments and at least one of the generated content segments includes a sentence, a paragraph, a language phrase, a language term, audio content, image content, or video content.
Clause 23. The system of clause 21, further comprising: means for inputting the source content segments and the generated content segments to a generative artificial intelligence model; and means for querying the generative artificial intelligence model to indicate a relevancy correspondence between each generated segment of the generated content segments and a corresponding input segment of the source content segments predicted most likely to generate the generated segment, each relevancy correspondence indicating a confidence score.
Clause 24. The system of clause 23, wherein the explanation indicates at least one generated result correspondence selected between the individual content segments of the source content and the individual generated content segments of the artificial-intelligence-generated content.
Clause 25. The system of clause 23, further comprising: means for selecting, for each corresponding pair of content segments, a similarity correspondence or a relevancy correspondence based on either a corresponding similarity score or a corresponding confidence score satisfying an interleaved explanation logic condition; and means for adding the similarity correspondence or the relevancy correspondence selected for each corresponding pair of content segments to the explanation that is output to the user interface device.
Clause 26. The system of clause 21, further comprising: means for ranking the generated result correspondences to yield ranked generated result correspondences; and limiting the explanation to include a predefined number of the ranked generated result correspondences.
Clause 27. The system of clause 21, further comprising: means for providing a block list of content segments to be filtered out of the source content; and means for filtering out segments in the block list before determining the generated result correspondences between the individual content segments of the source content and the individual generated content segments of the artificial-intelligence-generated content.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic May include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of generating an explanation of artificial-intelligence-generated content corresponding to source content, the method comprising:
embedding source content segments of the source content to generate input vectors of the source content segments;
embedding generated content segments of the artificial-intelligence-generated content to generate output vectors of the generated content segments;
performing a similarity measurement on the input vectors and the output vectors to generate a similarity score for each pair of input vectors and output vectors;
defining a similarity correspondence between individual content segments of the source content to individual generated content segments of the artificial-intelligence-generated content, based on performing the similarity measurement; and
outputting the explanation to a user interface device, wherein the explanation indicates generated result correspondences between the individual content segments of the source content and the individual generated content segments of the artificial-intelligence-generated content, based on defining the similarity correspondence between the individual content segments of the source content to the individual generated content segments of the artificial-intelligence-generated content.

2. The method of claim 1, wherein at least one of the source content segments and at least one of the generated content segments includes a sentence, a paragraph, a language phrase, a language term, audio content, image content, or video content.

3. The method of claim 1, further comprising:
inputting the source content segments and the generated content segments to a generative artificial intelligence model; and
querying the generative artificial intelligence model to indicate a relevancy correspondence between each generated segment of the generated content segments and a corresponding input segment of the source content segments predicted most likely to generate the generated segment, each relevancy correspondence indicating a confidence score.

4. The method of claim 3, wherein the explanation indicates at least one generated result correspondence selected between the individual content segments of the source content and the individual generated content segments of the artificial-intelligence-generated content.

5. The method of claim 3, further comprising:
selecting, for each corresponding pair of content segments, a similarity correspondence or a relevancy correspondence based on either a corresponding similarity score or a corresponding confidence score satisfying an interleaved explanation logic condition; and
adding the similarity correspondence or the relevancy correspondence selected for each corresponding pair of content segments to the explanation that is output to the user interface device.

6. The method of claim 1, further comprising:
ranking the generated result correspondences to yield ranked generated result correspondences; and
limiting the explanation to include a predefined number of the ranked generated result correspondences.

7. The method of claim 1, further comprising:
providing a block list of content segments to be filtered out of the source content; and
filtering out segments in the block list before determining the generated result correspondences between the individual content segments of the source content and the individual generated content segments of the artificial-intelligence-generated content.

8. A system for generating an explanation of artificial-intelligence-generated content corresponding to source content, the system comprising:
one or more hardware processors;
one or more embedding models executable by the one or more hardware processors and configured to embed source content segments of the source content to generate input vectors of the source content segments and to embed generated content segments of the artificial-intelligence-generated content to generate output vectors of the generated content segments;
a similarity evaluator executable by the one or more hardware processors and configured to perform a similarity measurement on the input vectors and the output vectors to generate a similarity score for each pair of input vectors and output vectors; and
an explanation builder executable by the one or more hardware processors and configured to define a similarity correspondence between individual content segments of the source content to individual generated content segments of the artificial-intelligence-generated content based on the similarity score satisfying a similarity condition, based on performing the similarity measurement, wherein the explanation builder is further configured to output the explanation to a user interface device, wherein the explanation indicates generated result correspondences between the individual content segments of the source content and the individual generated content segments of the artificial-intelligence-generated content, based on defining the similarity correspondence between the individual content segments of the source content to the individual generated content segments of the artificial-intelligence-generated content.

9. The system of claim 8, wherein at least one of the source content segments and at least one of the generated content segments includes a sentence, a paragraph, a language phrase, a language term, audio content, image content, or video content.

10. The system of claim 8, further comprising:
a generative artificial intelligence model executable by the one or more hardware processors and configured to receive the source content segments and the generated content segments to the generative artificial intelligence model and querying the generative artificial intelligence model to indicate a relevancy correspondence between each generated segment of the generated content segments and a corresponding input segment of the source content segments predicted most likely to generate the generated segment, each relevancy correspondence indicating a confidence score.

11. The system of claim 10, wherein the explanation indicates at least one generated result correspondence selected between the individual content segments of the source content and the individual generated content segments of the artificial-intelligence-generated content based on each confidence score satisfying a relevancy condition.

12. The system of claim 10, further comprising:
an explanation interleave logic processor executable by the one or more hardware processors and configured to select, for each corresponding pair of content segments, a similarity correspondence or a relevancy correspondence based on either a corresponding similarity score or a corresponding confidence score satisfying an interleaved explanation logic condition, the explanation interleave logic processor being further configured to add the similarity correspondence or the relevancy correspondence selected for each corresponding pair of content segments to the explanation that is output to the user interface device.

13. The system of claim 8, further comprising:
a generated segment processor executable by the one or more hardware processors and configured to rank the generated result correspondences to limit the explanation to include a predefined number of ranked generated result correspondences.

14. The system of claim 8, further comprising:
a block list model executable by the one or more hardware processors and configured to generate a block list of content segments to be filtered out of the source content; and
a filter executable by the one or more hardware processors and configured to filter out the content segments in the block list before determining the generated result correspondences between the individual content segments of the source content and the individual generated content segments of the artificial-intelligence-generated content.

15. One or more tangible processor-readable storage media embodied with instructions for executing on one or more processors and circuits of a computing device a process for generating an explanation of artificial-intelligence-generated content corresponding to source content, the process comprising:
embedding source content segments of the source content to generate input vectors of the source content segments, wherein at least one of the source content segments includes a sentence, a paragraph, a language phrase, a language term, audio content, image content, or video content;
embedding generated content segments of the artificial-intelligence-generated content to generate output vectors of the generated content segments, wherein at least one of the generated content segments includes a sentence, a paragraph, a language phrase, a language term, audio content, image content, or video content;
performing a similarity measurement on the input vectors and the output vectors to generate a similarity score for each pair of input vectors and output vectors;
defining a similarity correspondence between individual content segments of the source content to individual generated content segments of the artificial-intelligence-generated content based on the similarity score satisfying a similarity condition, based on performing the similarity measurement; and
outputting the explanation to a user interface device, wherein the explanation indicates generated result correspondences between the individual content segments of the source content and the individual generated content segments of the artificial-intelligence-generated content, based on defining the similarity correspondence between the individual content segments of the source content to the individual generated content segments of the artificial-intelligence-generated content.

16. The one or more tangible processor-readable storage media of claim 15, wherein the process further comprises:
inputting the source content segments and the generated content segments to a generative artificial intelligence model; and
querying the generative artificial intelligence model to indicate a relevancy correspondence between each generated segment of the generated content segments and a corresponding input segment of the source content segments predicted most likely to generate the generated segment, each relevancy correspondence indicating a confidence score.

17. The one or more tangible processor-readable storage media of claim 16, wherein the explanation indicates at least one generated result correspondence selected between the individual content segments of the source content and the individual generated content segments of the artificial-intelligence-generated content based on each confidence score satisfying a relevancy condition.

18. The one or more tangible processor-readable storage media of claim 16, wherein the process further comprises:
selecting, for each corresponding pair of content segments, a similarity correspondence or a relevancy correspondence based on either a corresponding similarity score or a corresponding confidence score satisfying an interleaved explanation logic condition; and
adding the similarity correspondence or the relevancy correspondence selected for each corresponding pair of content segments to the explanation that is output to the user interface device.

19. The one or more tangible processor-readable storage media of claim 15, wherein the process further comprises:
ranking the generated result correspondences to yield ranked generated result correspondences.

20. The one or more tangible processor-readable storage media of claim 15, wherein the process further comprises:
providing a block list of content segments to be filtered out of the source content; and
filtering out the content segments in the block list before determining the generated result correspondences between the individual content segments of the source content and the individual generated content segments of the artificial-intelligence-generated content.
